(19) United States
(12) Patent Application Publication
(10) Pub. No.: US 2015/0326517 A1
(43) Pub. Date: Nov. 12, 2015

(54) SYSTEM AND METHOD FOR DELIVERING INFORMATION VIA SECURE ELECTRONIC MESSAGING

(71) Applicant: Ingenium Business Solutions, Inc., North Miami, FL (US)

(72) Inventors: Andrew Block, Boca Raton, FL (US); Chris Almond, North Miami, FL (US)

(73) Assignee: Ingenium Business Solutions, Inc., North Miami, FL (US)

(21) Appl. No.: 14/274,986

(22) Filed: May 12, 2014

(51) Int. Cl. H04L 12/58; H04L 29/08; G06F 17/30; H04L 29/06

(52) U.S. Cl. CPC H04L 51/08; H04L 63/083; H04L 67/12; G06F 17/30882

(57) ABSTRACT

A computer-implemented system for delivering information comprising: a sender device with an email client for composing and sending an original email message to a Simple Mail Transfer Protocol (SMTP) listener server with encryption enabled; a message processor that extracts the message body payload from the email message, stores it in a database, and creates a new email message with a message body containing a reference to the message body of the original email message; a file repository for storage of attachments to the email message; and an SMTP sender that sends the new email message to a recipient mail server. The listener server assigns the message to the message processor, and the new email message contains links to the attachments residing in the file repository. A method utilizing the system described above.

### BACKGROUND OF THE INVENTION

1. Field of the Invention

The present invention relates generally to the field of computer-implemented inventions, and more specifically, to a system and method for delivering information via secure electronic messaging.

2. Description of the Related Art

With the enactment of the Health Insurance Portability & Accountability Act of 1996 (“HIPAA”) and the Health Information Technology for Economic and Clinical Health Act (“HITECH”) enacted as part of the American Recovery and Reinvestment Act of 2009, covered entities (a/k/a healthcare providers) are required to protect sensitive patient data in several ways. This data, which might include, for example, a unique patient identifier and personal health information, is referred to in electronic format as ePHI (electronic protected health information) and must be secured. The HIPAA Security Rule defines a set of requirements for ePHI. Access to ePHI must only be allowed by those authorized to access it, the transmission ePHI must be performed in a secure manner, and access to ePHI must be logged.

Healthcare providers need a way to send secure email easily with minimal effort on the part of the sender and the recipient. Secure messaging services currently on the market require the use of encryption keys and complex authentication processes consisting of a series links and logins in order to send and receive the email in a secure manner. Another drawback is the fact that the contents of the secure message may only be accessed from outside of the recipient's preferred email client. Furthermore, some services require users to adopt a new email address or update their domain name system (DNS) mail exchanger (MX) records in order to function.

An overall objective of the present invention is to make the process described above easy for both the sender and recipient while also being device-agnostic. As used herein, the term “device” means any device on which software may be installed, including, but not limited to, a laptop computer, desktop computer, tablet computer, mobile phone or any other kind of mobile device. As described more fully below, the present invention allows the sender to keep his email address and simply hit the send button in his preferred email client. On the receiving end, the recipient views the secure message within her preferred email client or mobile device once she is authenticated; when the secure message is received, the recipient clicks a link within the secure message and is directed to a login screen. Following login with an email address and password, all subsequent messages (including the current one) display the secure message content within the recipient's email client.

### BRIEF SUMMARY OF THE INVENTION

The present invention is a computer-implemented system for delivering information comprising: a sender device with an email client for composing and sending an original email message with a message body, the message body having a message body payload, to a Simple Mail Transfer Protocol listener server with encryption enabled, the email client configured to use outbound authentication for outbound username and password credentials, wherein the listener server receives incoming Simple Mail Transfer Protocol email messages and only accepts inbound Simple Mail Transfer Protocol messages from senders who are authenticated; a message processor that extracts the message body payload from the email message, stores it in a database, and creates a new email message with a message body containing a reference to the message body of the original email message; a file repository for storage of attachments to the email message, wherein the message processor stores attachments to the email message in the file repository; and a Simple Mail Transfer Protocol sender that sends the new email message to a recipient mail server; wherein the listener server assigns the message to the message processor; and wherein the new email message contains links to the attachments residing in the file repository.

In a preferred embodiment, the message body of the original email message is replaced with a Hyper Text Markup Language image tag inside a Hyper Text Markup Language anchor tag, and a Hyper Text Markup Language anchor link is provided for each attachment; the image tag has a query string and a source Uniform Resource Locator that points to a view message image resource on the message portal; the query string of the image tag contains a message token that references the message body of the original email message; the message token is an encoded string that contains a message unique identifier and a message received date; and when the anchor tag is clicked, the anchor tag directs the recipient to the message portal, where the recipient can log in and view the original email message within a message portal interface.

In a preferred embodiment, if the original email message contains attachments, each attachment has a hypertext reference, and the hypertext reference for each attachment points to a Uniform Resource Locator with a query string that contains an attachment token; the attachment token references the attachment in the original message body; and the attachment token is an encoded string that contains the message unique identifier, an attachment unique identifier, and the message received date.

The present invention is also a computer-implemented method for delivering information comprising: extracting and storing on a secure server a message body payload of an original email message with a message body, the message body having content; creating a new email message that contains a reference to the message body payload residing on the secure server; sending the new email message with the reference to the message body payload to a recipient via the Internet, the recipient having an email client; and, if the recipient is authenticated, delivering the message body payload to the recipient's email client as a first image that contains the message body content without requiring the user to take any additional steps. If the recipient is not authenticated, the method further comprises delivering a second image within a Hyper Text Markup Language link to the email client directing the recipient to click the second image to view the message body content, the second image not containing any of the message body of the original email message; when the second image is clicked by the recipient, opening a web browser and directing the recipient to a secure Internet server login page on which the message body payload resides; and displaying the message body to the recipient once the recipient is authenticated.

In a preferred embodiment, the step of delivering the message body payload to the recipient's email client as a first image that contains the message body content includes retrieving the message body of the original email message from a database and generating a graphic image file rendering of the message body content. Preferably, the step of displaying the message body to the recipient includes retrieving the message body of the original email message from a database and generating a graphic image file rendering of the message body content.

### BRIEF DESCRIPTION OF THE DRAWINGS

FIG. 1 is a diagram of the system architecture of the present invention.

FIG. 2 is a flow diagram of the secure message sending process of the present invention.

FIG. 3 is a flow diagram of the secure message receiving process of the present invention.

FIG. 4 is a flow diagram of the secure message authentication process of the present invention.

FIG. 5 is an illustration of the login page for the message portal.

FIG. 6 is an illustration of a web mail client interface where a non-authenticated recipient is viewing the message content redirecting the recipient to the message portal.

FIG. 7 is an illustration of a web mail client interface where an authenticated recipient is viewing the original message content rendered as an image.

FIG. 8 is an illustration of a recipient viewing the original message content in the message portal.

### DETAILED DESCRIPTION OF INVENTION

### A. Overview

The present invention is a computer-implemented system and method for sending secure email messages that are compliant with HIPAA. This is accomplished by extracting and storing the message body payload in a secure server prior to sending the email on to its recipient via the Internet. The message body is replaced with a reference to the original message body payload, which resides on a secure Internet-accessible server.

The process begins with a person sending an email message from a preferred email client or via the secure mail server web user interface. In a preferred embodiment, the outbound email settings of the email client are configured to send via Secure Sockets Layer (SSL) to the secure server. Upon receipt of the email from the sender's email client, the message body payload is extracted from the email message and stored on the secure server. A new message is created and emailed via the Internet; the body of this new message contains a reference to the original message body payload residing on the secure server.

Upon receipt of the secure email by a recipient, the recipient's email client attempts to obtain the message body payload located on the secure Internet server as directed by the reference. If the recipient has been authenticated, the message body payload is delivered to the recipient's email client as an image that contains the message body content. If the recipient is not authenticated, an image within a Hyper Text Markup Language (HTML) link is delivered to the email client directing the recipient to click the image to view the secure message content.

When the image is clicked by the recipient, a web browser is opened, and the recipient is directed to the secure Internet server login page on which the secure message body payload resides. Once the recipient is authenticated, the secure message body content is displayed.

### B. Detailed Description of the Figures

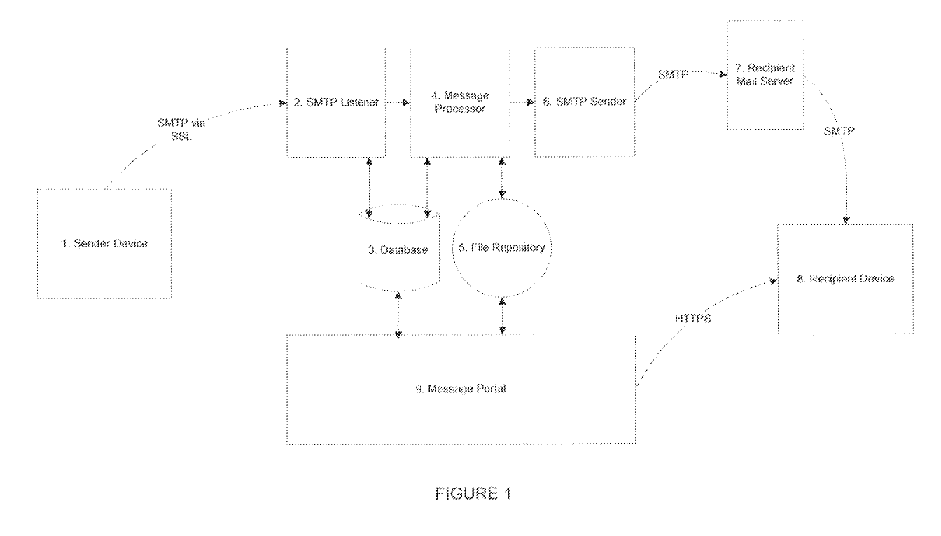

FIG. 1 is a diagram of the system architecture of the present invention. As shown in this figure, the sender device 1 is a laptop, desktop computer, or smartphone. A sender uses the sender device to compose and send an email message via Simple Mail Transfer Protocol (SMTP) over SSL to the SMTP listener server 2. The sender configures his client to send outbound email to the SMTP listener server with SSL encryption enabled. In addition, the email client is configured to use outbound authentication setting the outbound SMTP username and password credentials. With the combination of SSL encryption and user authentication for the outbound sending of email, a secure and authenticated channel is established from the sender's client device to the SMTP listener server.

The SMTP listener server, message processor 4, and SMTP sender 6 constitute a multithreaded software system. The SMTP listener server receives incoming SMTP email messages and only accepts inbound SMTP messages from senders who are authenticated. The SMTP listener server authenticates senders by verifying the username and password stored in the database and then assigns the message to message processor. The database 3 is a relational database management system (RDMS) such as MICROSOFT SQL SERVER™.

The message processor extracts the message body payload from the message and stores it in the database. Any attachments on the message are placed in the file repository 5. The file repository may be any file storage system, such as MICROSOFT SERVER™ or a storage area network (SAN). The message processor then creates a new message whose body has a reference to the original message body payload along with links to the attachments residing in the file repository. The SMTP sender then sends the secure message to the recipient mail server 7 via SMTP over the Internet.

The recipient mail server may take the form of any commercial or non-commercial email service provider or email server, including, but not limited to, GMAIL™, YMAIL™, or a corporate email server system such as MICROSOFT EXCHANGE SERVER™. The recipient device 8 is a computer workstation, laptop, tablet computer, smart phone, or any other device that is configured to receive email. The recipient uses an email client or web-based email service to access the secure message residing on the recipient mail server.

The message portal 9 is an application web server such as MICROSOFT INTERNET INFORMATION SERVER™. In the event the recipient is not yet authenticated, the recipient would connect to the message portal over SSL and the Internet using a web browser and authenticate via a login screen. Once authenticated, the recipient may view the secure message either from the message web portal web interface or from the email client on the recipient's device.

In the case where the sender does not have an email client on the sender's device, the sender may connect to the message portal via a web browser and compose and send a secure message on the portal.

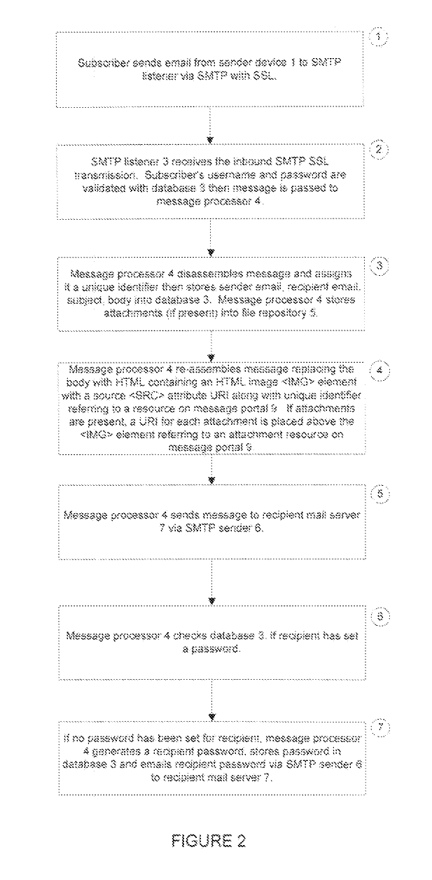

FIG. 2 is a flow diagram of the secure message sending process of the present invention. This figure describes how the components of the software handle receipt of the original message and construct, store and send a secure message.

At step 1, the sender (who is a subscriber of the secure email service) uses his email client to send an email message to the SMTP listener. The email client connects to the SMTP listener via SMTP SSL on the Internet.

At steps 2 and 3, the SMTP listener receives the inbound SMTP transmission and validates the sender's username and password credentials against those stored in the database. The inbound message is then passed to the message processor, where it is decrypted and disassembled. The message is assigned a unique reference identifier (typically a sequential number assigned by the SQL server), and the message sender, recipient(s), subject and body are stored in the database. Attachments, if present, are stored in the file repository and assigned a unique identifier.

At step 4, the message processor creates a new message by re-assembling the parts of the original message with the exception of the body. The body is replaced with HTML markup with the following elements: (i) an HTML image tag inside an HTML anchor tag; and (ii) an HTML anchor link for each attachment. The source (SRC) Uniform Resource Locator (URL) for the HTML image tag points to a view message image resource on the message portal. The query string of the HTML image tag contains a message token that references the body of the original message; the message token is an encoded string that contains the message unique identifier and the message received date. When the client browser requests the image from the message portal, the portal renders an image representing the original message body content only if the user has been authenticated. If not, an image instructing the user to click here to see the content of the message is rendered.

The HTML anchor tag points to a view message resource on the message portal. The query string of the HTML anchor tag also contains the message token that corresponds to the original message (that is, the same message token that is contained within the query string of the HTML image tag). When clicked, the anchor tag will direct the user's web browser to the message portal where the user can log in and view the secure message within the message portal interface. A successful log in authenticates the user. The portal knows which message the user is requesting based on the embedded query string token. If attachments are present, the hypertext reference (HREF) for each attachment points to a URL with a query string that contains an attachment token. The attachment token references the attachment in the original message body; the attachment token is an encoded string that contains the message unique identifier, the attachment unique identifier, and the message received date.

At step 5, the message portal engages the SMPT sender to send the new email message to the recipient mail server via SMTP and the Internet. Because the original message body and its attachments have been removed and stored on the database and file repository and replaced with references to these elements, the new message being sent contains no sensitive information and is safe to be sent via standard SMTP and Internet.

At steps 6 and 7, in the event the recipient is not a subscriber in the system, the recipient will need a temporary password to access the contents of the secure message, which reside in the database and file repository. The message processor checks the database to see if there is a password set for the recipient; if not, then the message processor sets a temporary password for the recipient and stores it in the database. The message processor then sends a second email message to the recipient via the SMTP sender containing the temporary password.

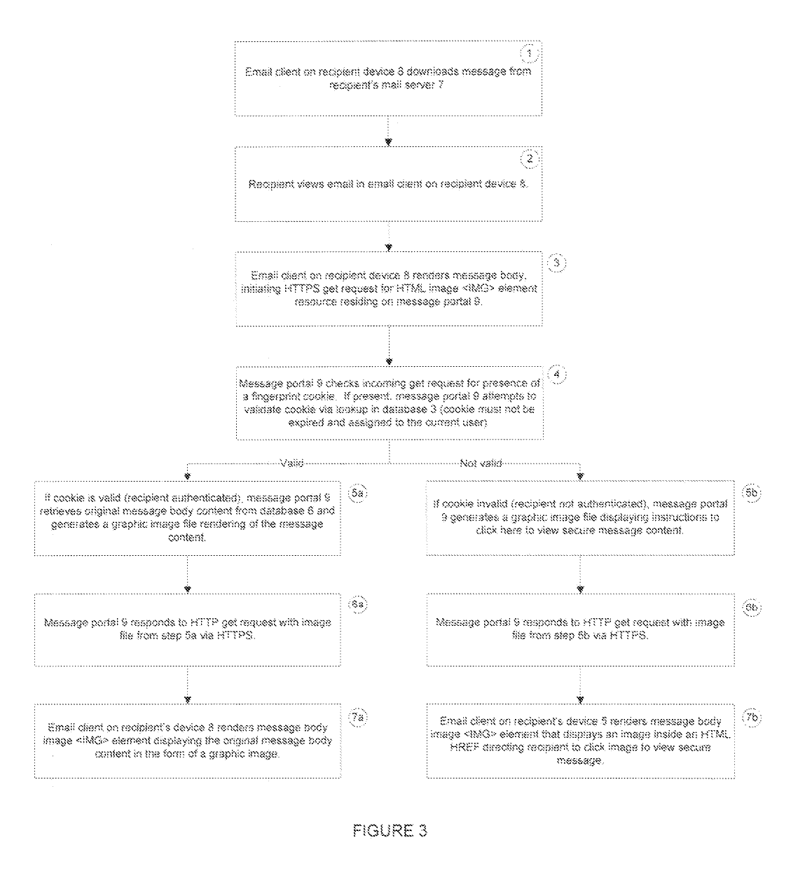

FIG. 3 is a flow diagram of the secure message receiving process of the present invention. This figure describes how the recipient accesses and views the email message and its secure contents.

At steps 1 and 2, the recipient downloads the message from the recipient mail server onto the recipient device using an email client such as MICROSOFT OURLOOK™. Alternately, the recipient may view the message via webmail from within a web browser on the recipient's device.

At step 3, the email client or web browser attempts to render the message. During this process, the email client or web browser sends to the message portal a hypertext transfer protocol secured (HTTPS) get request for the embedded HTML <IMG> element tag located in the email body's HTML markup.

At step 4, the message portal receives the incoming get request from the recipient device and checks for the presence of a fingerprint cookie residing on the recipient device. If the cookie is present, the message portal looks up this cookie in the database and checks that it has not expired and that the cookie is associated with a user who is either a sender or recipient on the current message. If both are true, then the cookie is considered valid.

At steps 5a and 6a, if the fingerprint cookie is valid, then the message portal retrieves the original message body content from the database and generates a graphic image file rendering of the message content. This graphic image file contains a rendering of all of the message body content, including text and embedded images of the original message. In this case, the entire original message body is delivered in the form of an image rather than its original multipurpose Internet mail extension (MIME) text markup. The message portal then responds to the HTTP get request and returns this image file via HTTPS to the requesting recipient device.

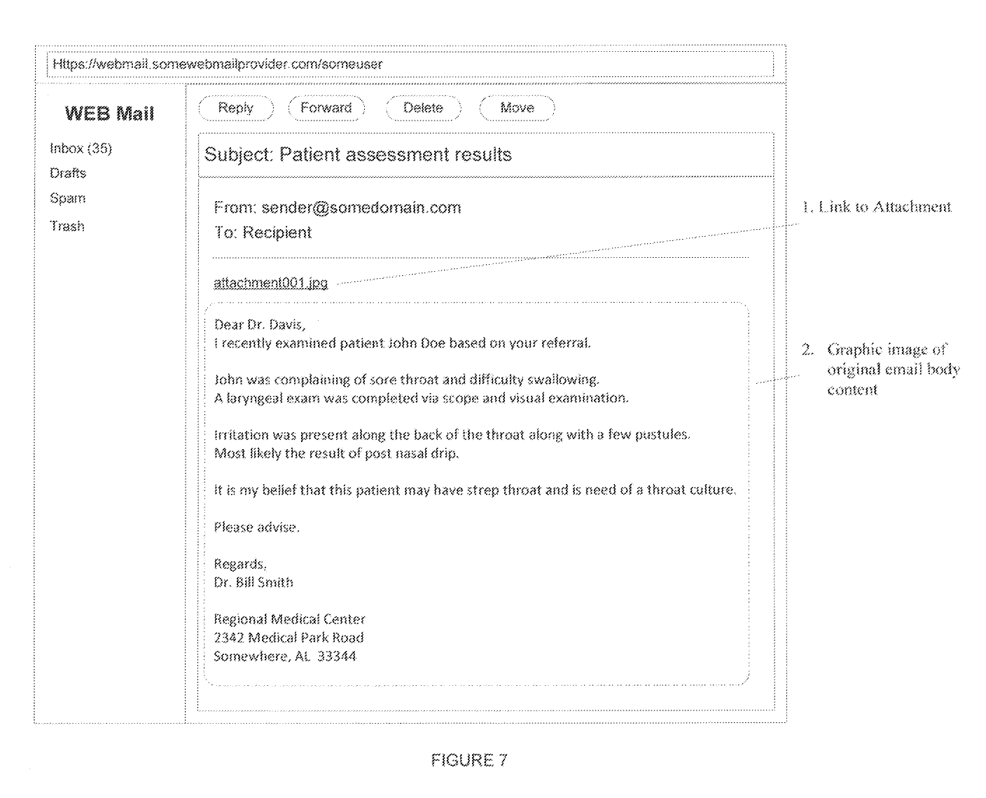

At step 7a, the email client or web browser on the recipient's device renders the message body <IMG> element displaying the original message body content in the form of a graphic image. The result is shown in FIG. 7.

The distinguishing factor to note here is that the recipient, if she were already authenticated and had a valid fingerprint cookie, is able to view the contents of the original message within her email client or web browser without having to log in again and without having to click a link and be taken to another website or resource in order to view the message content. The message content is display directly as if it were sent via standard SMTP. No additional steps are required on the part of the email recipient to view the contents of the secure message.

At steps 5b and 6b, if the fingerprint cookie is invalid (i.e., the recipient is not authenticated), the message portal generates a graphic image file displaying instructions to click here to view the secure message content. The message portal then responds to the HTTP get request from the recipient's device and delivers this image via HTTPS. In this case, the image sent to the recipient device does not contain any of the original message body. It simply directs the recipient to click on the image in the message body in order to access the original message body.

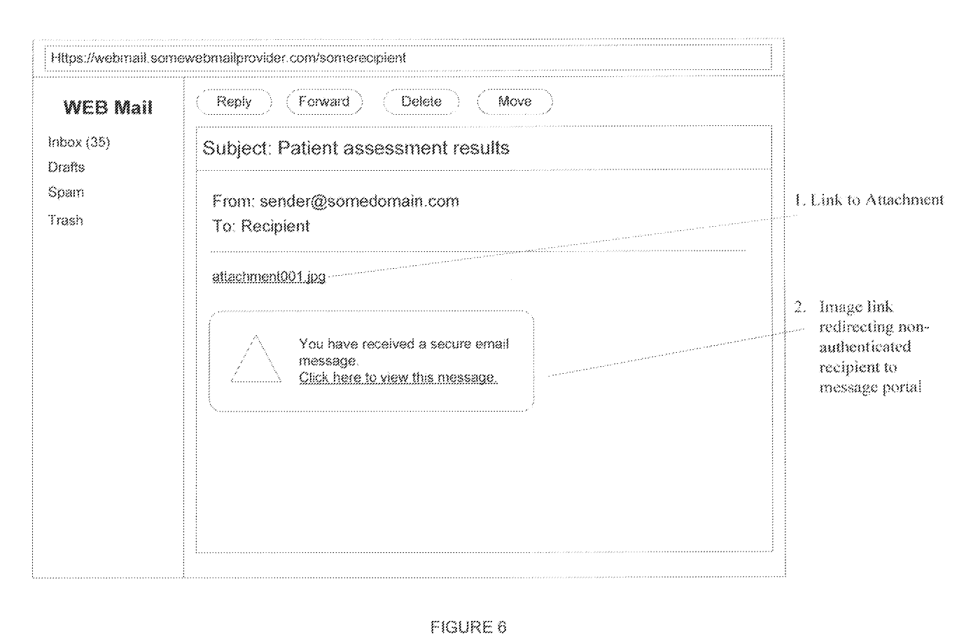

At step 7b, the email client or web browser on the recipient's device renders the message body image <IMG> element, which displays an image contained within an HTML anchor tag with an HREF directing the recipient hack to the message portal in order to view the original message. The result is shown in FIG. 6.

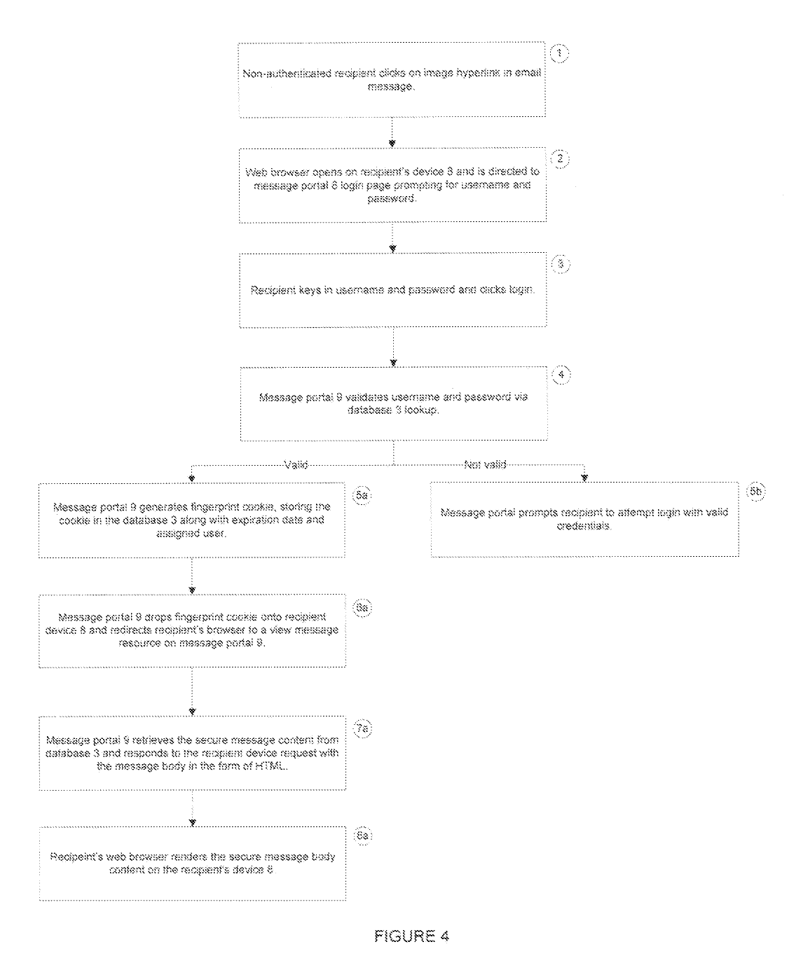

FIG. 4 is a flow diagram of the secure message authentication process of the present invention. This figure outlines the process for a recipient user to authenticate and obtain a valid fingerprint cookie on the recipient device. A non-authenticated recipient is one who does not have a valid fingerprint cookie residing on the recipient device. At this point in the process, the recipient has received a message that displays an image directing her to click on the image to view the secure contents of the originating email message. The result is shown in FIG. 6 for a webmail client.

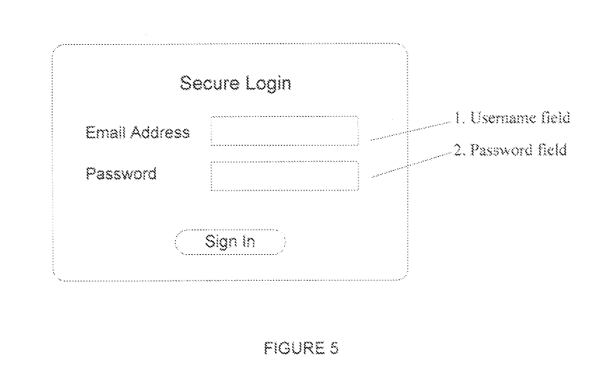

At steps 1 and 2, a non-authenticated recipient clicks on the image displayed in the web browser webmail client or email client. A new web browser window is opened on the recipient device and is directed to the message portal login page, which prompts for username and password. The query string of the URL directing the recipient to the login page contains a message token that references the original email message; as noted above, the message token is an encoded string that contains the message unique identifier and the message received date. The result is shown in FIG. 5.

At step 3, the recipient keys in the username and password and clicks the login button. At step 4, the message portal attempts to validate the username and password via database lookup. If a matching username and password are found, then these credentials are considered valid by the message portal.

At step 5a, if the credentials are valid, the message portal generates a fingerprint cookie and stores this cookie, along with the expiration date and associated user, in the database. The fingerprint cookie is an encoded string with the user ID and current date and time. The user ID is assigned by the database when the user account is created. In a typical case, the user ID is a sequential unique number.

At step 6a, the message portal instructs the web browser on the recipient device to store the fingerprint cookie on the recipient device. The message portal then redirects the recipient's web browser to a view message resource residing on the message portal. The query string of the redirect URL still contains the message token (the same message token that was in the query string of the URL directing the recipient to the login page) because it was part of the original HTTP request.

At step 7a, using the message token, the message portal retrieves the secure message content from the database and responds to the recipient device request with the message body in the form of HTML. The HTML message body contents are returned to the recipient's web browser securely via SSL and HTTPS.

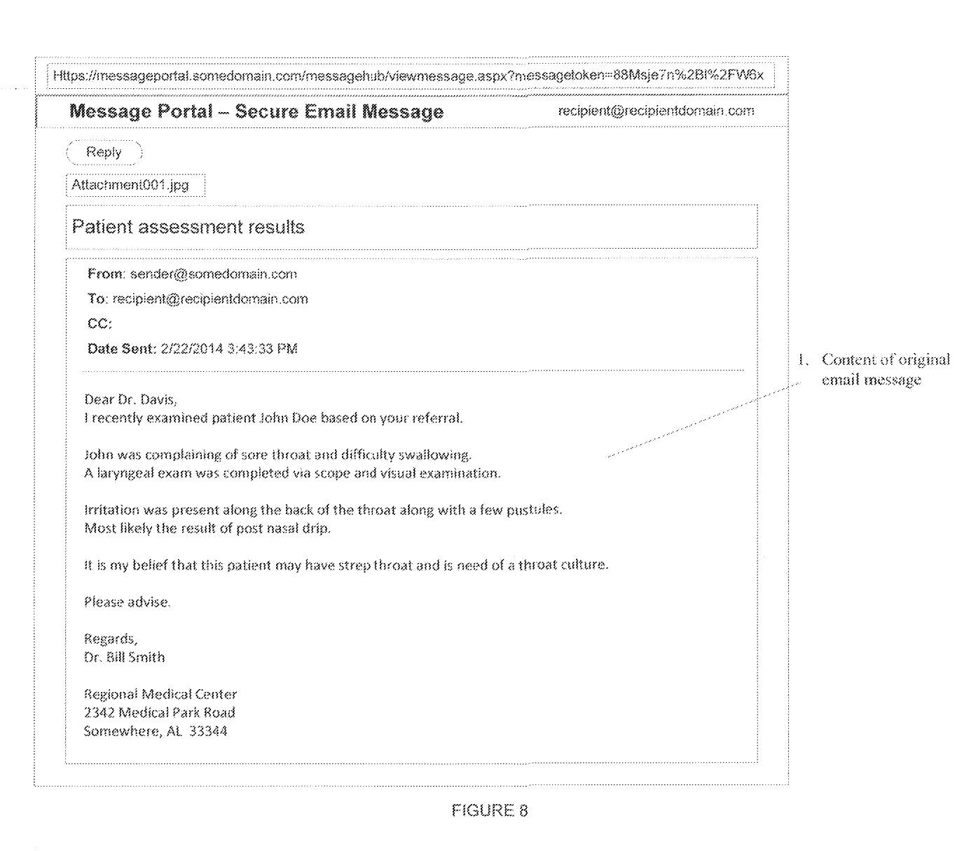

At step 8a, the recipient's web browser renders the secure message body content on the recipient device. The result is shown in FIG. 8.

FIG. 5 is an illustration of the login page for the message portal. The login page residing on the message portal contains a username field, a password field and a sign in button. The recipient would type her email address into the username field, her password into the password field, and then click the sign in button to attempt authentication with the message portal.

FIG. 6 is an illustration of a web mail client interface where a non-authenticated recipient is viewing the message content redirecting the recipient to the message portal. In this figure, the recipient is viewing this email message from within her web mail interface on a web browser located on the recipient device. In this case, the recipient is not yet authenticated. As a result, the HTML markup in the recipient's mail message renders an image link provided by the message portal that directs the recipient to click to access the content of the secure message. A link to the message attachment is also provided above the image.

FIG. 7 is an illustration of a web mail client interface where an authenticated recipient is viewing the original message content rendered as an image. In this case, the recipient is authenticated (i.e., she have a valid fingerprint cookie residing on the recipient device). The message portal detects the presence of a valid fingerprint cookie and delivers to the recipient's browser a graphic image with the contents of the original email message body. A link to an attachment in the original email message is presented above the image.

FIG. 8 is an illustration of a recipient viewing the original message content in the message portal. In this case, the recipient has clicked on the link in the received email message. The recipient's browser is directed to the view message resource located on the message portal. The view message resource renders the original content of the requested message within the recipient's web browser located on the recipient device.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A computer-implemented system for delivering information comprising:
(a) a sender device with an email client for composing and sending an original email message with a message body, the message body having a message body payload, to a Simple Mail Transfer Protocol listener server with encryption enabled, the email client configured to use outbound authentication for outbound username and password credentials, wherein the listener server receives incoming Simple Mail Transfer Protocol email messages and only accepts inbound Simple Mail Transfer Protocol messages from senders who are authenticated;
(b) a message processor that extracts the message body payload from the email message, stores it in a database, and creates a new email message with a message body containing a reference to the message body of the original email message;
(c) a file repository for storage of attachments to the email message, wherein the message processor stores attachments to the email message in the file repository; and
(d) a Simple Mail Transfer Protocol sender that sends the new email message to a recipient mail server,
wherein the listener server assigns the message to the message processor; and
wherein the new email message contains links to the attachments residing in the file repository.

2. The system of claim 1, wherein the message body of the original email message is replaced with a Hyper Text Markup Language image tag inside a Hyper Text Markup Language anchor tag, and wherein a Hyper Text Markup Language anchor link is provided for each attachment;
wherein the image tag has a query string and a source Uniform Resource Locator that points to a view message image resource on the message portal;
wherein the query string of the image tag contains a message token that references the message body of the original email message;
wherein the message token is an encoded string that contains a message unique identifier and a message received date; and
wherein when the anchor tag is clicked, the anchor tag directs the recipient to the message portal, where the recipient can log in and view the original email message within a message portal interface.

3. The system of claim 2, wherein if the original email message contains attachments, each attachment has a hypertext reference, and the hypertext reference for each attachment points to a Uniform Resource Locator with a query string that contains an attachment token;
wherein the attachment token references the attachment in the original message body; and
wherein the attachment token is an encoded string that contains the message unique identifier, an attachment unique identifier, and the message received date.

4. A computer-implemented method for delivering information comprising:
(a) extracting and storing on a secure server a message body payload of an original email message with a message body, the message body having content;
(b) creating a new email message that contains a reference to the message body payload residing on the secure server;
(c) sending the new email message with the reference to the message body payload to a recipient via the Internet, the recipient having an email client;
(d) if the recipient is authenticated, delivering the message body payload to the recipient's email client as a first image that contains the message body content without requiring the user to take any additional steps; and
(e) if the recipient is not authenticated,
(i) delivering a second image within a Hyper Text Markup Language link to the email client directing the recipient to click the second image to view the message body content, the second image not containing any of the message body of the original email message;
(ii) when the second image is clicked by the recipient, opening a web browser and directing the recipient to a secure Internet server login page on which the message body payload resides; and
(iii) displaying the message body to the recipient once the recipient is authenticated.

5. The method of claim 4, wherein the step of delivering the message body payload to the recipients email client as a first image that contains the message body content includes retrieving the message body of the original email message from a database and generating a graphic image file rendering of the message body content.

6. The method of claim 4, wherein the step of displaying the message body to the recipient includes retrieving the message body of the original email message from a database and generating a graphic image file rendering of the message body content.
